(19) United States
(12) Patent Application Publication
(10) Pub. No.: US 2012/0299822 A1
(43) Pub. Date: Nov. 29, 2012

(54) Communication and Device Control System Based on Multi-Frequency, Multi-Phase Encoded Visual Evoked Brain Waves

(75) Inventors: Po-lei Lee, Jhongli City (TW); Kuo-kai Shyu, Jhongli City (TW); Chi-hsun Wu, Jhongli City (TW); Jyun-jie Sie, Jhongli City (TW); Ming-huan Lee, Jhongli City (TW)

(73) Assignee: National Central University

(21) Appl. No.: 13/561,283

(22) Filed: Jul. 30, 2012

Related U.S. Application Data
(63) Continuation-in-part of application No. 12/179,639, filed on Jul. 25, 2008, now abandoned.

(51) Int. Cl. G06F 3/01

(52) U.S. Cl. 345/156

(57) ABSTRACT

A driving control system actuated by visual evoked brain waves which are induced by a multi-frequency and multi-phase encoder, the driving control system includes an optical flash generating device, a brain wave signal measurement device, a signal processing and analyzing device and a control device. The brain wave signal measurement device is configured for measuring a steady-state visual evoked response (SSVER) signal inducing by a user gazing the flash light source generated by the optical flash generating device. The signal processing and analyzing device is configured for calculating the frequency parameter and the phase parameter of the SSVER signal by a mathematical method, and analyzing whether those parameters are same as the optical flash generating device's parameters so as to generate a judgment result. The control device generates a control command according to the judgment result for controlling at least one of peripheral equipments.

### CROSS-REFERENCES TO RELATED APPLICATIONS

This application is a continuation-in-part of my co-pending application Ser. No. 12/179,639 filed Jul. 25, 2008

### BACKGROUND OF THE INVENTION

1. Field of the Invention

The present invention relates to a driving control system actuated by visual evoked brain waves which are induced by a multi-frequency, multi-phase encoder, and a corresponding method configured for analyzing steady-state visual evoked response (SSVER) signals in order to control one or more peripheral equipments.

2. Description of the Related Art

With the rapid development of the modern technology, humankind can measure physiological signals, such as blood pressure, heart electrical activity, muscle electrical activity or brain electrical activity, by means of those advanced physiological measure technology in effectively, easily and noninvasive ways. By further analyzing and processing the physiological signals, the physiological signals can be utilized as a new interface for the communication between users and external environments. The developments of brain wave recording technology and the neurological science in recent years bring in the maturity of a new technology for users to communicate with external environments using his/her brain waves, independent of peripheral muscle nerve and activities. The technology is called brain computer interface (BCI).

The brain computer interface employs brain signals to make users communicate with external environments directly. The main issues for developing a BCI depend on: (1) designing a proper task to induce particular brain waves; (2) a signal processing step to extract the induced brain wave with high signal-to-noise ratio; (3) a signal processing step to distinguish the expected brain wave from task-unrelated brain waves; (4) one or more external devices controlled by the extracted brain wave.

Conventional human machine interface (HMI) for disabled patients mainly constructed by a voice control input interface or a body control keyboard input interface. However, some users, who are suffering from neural or muscular incapability and can not speak as sharpness as normal people, may have problem to operate the peripheral equipment. Besides, regarding the body control keyboard input interface, it includes a keyboard and a mouse, both of which are indispensable devices to operate the peripheral equipment. The body control keyboard interface may hurt people and induce various health problems, such as neck pain, poor blood circulation, muscle fatigue, etc., caused by uncomfortable posture and lack of body stretching, if a normal user uses the body control keyboard input interface for a long time. Furthermore, the body control keyboard input interface is also not suitable for the users, who are suffering from neural or muscular incapability.

The aforementioned HMIs of the peripheral equipment generally are only suitable for particular groups of patients who still can use voice or limb movement to operate the peripheral equipments. Those HMIs are not suitable for the users, who are suffering from neural or muscular incapabilities, having problem with voluntary speech or limb movements.

Accordingly, a system for solving the aforementioned problems is needed.

### SUMMARY OF THE INVENTION

A driving control system for visual evoked brain wave, induced by multi-frequency and multi-phase encoder, in accordance with an exemplary embodiment of the present invention is provided. The driving control system is configured for the use of brain wave signals to control at least one peripheral equipment. The driving control system includes an optical flash generating device, a brain wave signal measurement device, a signal processing and analyzing device, and a control device.

The optical flash generating device configured for generating at least one flash light source by a multi-frequency, multi-phase encoder, the optical flash generating device including a programmable chip and at least one light emitting element arranged therein, the programmable chip being configured to generate a multi-channel phase angle delay time by the multi-frequency, multi-phase encoder so as to drive the light emitting element to flash light source based on the multi-channel phase angle delay time, wherein each flash light source has a flash timing, and the flash light source from the light emitting element and next flash light source are compared to generate a phase difference. The brain wave signal measurement device configured for measuring a steady-state visual evoked response (SSVER) signal induced by a user gazing at the flash from the light emitting element, the brain wave signal measurement device, and the brain wave signal measurement device being one of 10-20 type systems designed by the International Brain Wave Association, the brain wave signal measurement device employing one electrode chip with positive attached on a brain optical zone (OZ) of the user, another electrode chip with negative attached on a postauricular mastoid, and the other electrode chip with ground attached on a forehead for measuring the SSVER signal generated, the brain wave signal measurement device including a brain measurement system, a signal amplifier, an analog-to-digital converter and a narrow band filter arranged therein, the brain measurement system being configured for measuring the SSVER signal, the signal amplifier being configured for amplifying the SSVER signal measured by the brain measurement system, the analog-to-digital converter being configured for digitizing the SSVER signal amplified by the signal amplifier, the narrow band filter being configured for filtering the SSVER signal converted by the analog-to-digital converter to eliminate brain wave not corresponding to the frequency of the flash light source, and advance signal-to-noise (S/N) ratio, so as to obtain sine brain wave with SSVER corresponding to the frequency of the flash light source. The signal processing and analyzing device configured for receiving the sine brain wave signal from the brain wave signal measurement device, calculating frequency and phase of the sine brain wave signal by mathematical method, and analyzing whether the frequency and the phase of the sine brain wave signal match to those of the optical flash generating device so as to generate a judgment result. The control device configured for generating a control command according to the judgment result and sending out the control command to control at least one peripheral equipment.

A method used into a driving control system for visual evoked brain wave by multi-frequency and multi-phase encoder, the method being configured for using brain wave signals to control at least one peripheral equipment, the method employing a signal processing and analyzing device of the driving control system to perform following steps: receiving a multi-channel phase angle delay time generated by a programmable chip with a multi-frequency and multi-phase encoder, the programmable chip transmitting the multi-channel phase angle delay time to at least one light emitting element for driving and flashing the at least one light emitting element, wherein each flash light source has a flash timing, and the flash light source from the light emitting element and next flash light source are compared to generate a phase difference; receiving the SSVER signal sent out from the brain wave signal measurement device being one of 10-20 type systems designed by the International Brain Wave Association, and attaching one electrode chip with positive on a brain optical zone (OZ), another electrode chip with negative on a postauricular mastoid, and the other electrode chip with ground on a forehead for receiving the SSVER signal generated by detecting the brain visual cortex area of the user gazing the at least one light emitting element, and amplifying the SSVER signal measured by a signal amplifier, and then converting the SSVER signal amplified from analog to digital by an analog-to-digital converter, and forming a reference signal based on the SSVER signal measured when a user initially gazes at the at least one light emitting element first time; eliminate the brain wave not corresponding to the frequency of the flash light source by a narrow band filter, and advancing signal-to-noise (S/N) ratio, so as to obtain sine brain wave with SSVER corresponding to the frequency of the flash light source, and performing a superposed average of the SSVER signal sent out from the brain wave signal measurement device and the sine brain wave with SSVER so as to compare with the reference signal; and transmitting a control command of the SSVER signal to a control device for controlling the at least one peripheral equipment, if the SSVER signal having both the same frequency parameter and phase parameter matched to those of the at least one light emitting element.

### BRIEF DESCRIPTION OF THE DRAWINGS

The invention, as well as its many advantages, may be further understood by the following detailed description and drawings in which:

FIG. 1 is a schematic, frame diagram of a driving control system, in accordance with an exemplary embodiment of the present invention;

FIG. 2 is a schematic, sequence chart for generating flash lights by an multi-frequency, multi-phase encoder of the present invention; and

FIG. 3 is a schematic, flowing chart for analyzing the signal of the present invention.

FIG. 4 is a schematic, superposed average procedural chart for the SSVER signal.

### DETAILED DESCRIPTION OF THE INVENTION

Reference will now be made to the drawings to describe exemplary embodiments of the present driving control system and method for visual evoked brain wave by multi-frequency phase encoder, in detail. The following description is given by way of example, and not limitation.

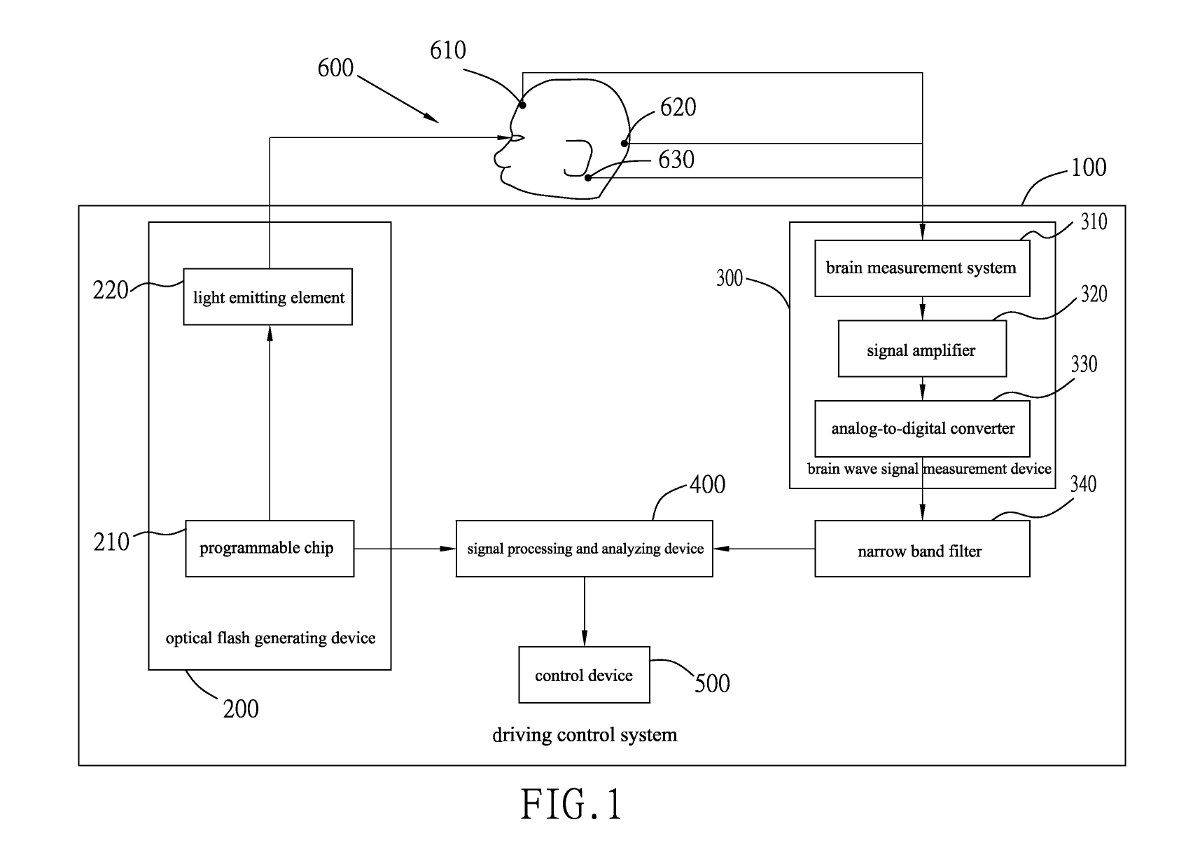

Referring to FIG. 1, a driving control system for visual evoked brain wave by multi-frequency and multi-phase encoder, in accordance with an exemplary embodiment of the present invention, is provided. The driving control system 100 includes an optical flash generating device 200, a brain wave signal measurement device 300, a signal processing and analyzing device 400 and a control device 500. The optical flash generating device 200 is configured for generating at least one flash light source by multi-frequency and multi-phase encoder. The optical flash generating device 200 includes a programmable chip 210 and at least one light emitting element 220. The programmable chip 210 is selected from one of a group consisting of a field programmable gate array (FPGA), a single chip and a microprocessor. The light emitting element 220 is selected from one of a group consisting of a light emitting diode (LED), a flash screen and an element configured for emitting visible light. The programmable chip 210 generates a multi-channel phase angle delay time by the multi-frequency and multi-phase encoder, and drives the light emitting element 220 to flash based on the multi-channel phase angle delay time. The brain wave signal measurement device 300 is configured for measuring a SSVER signal evoked by a user gazing at the flash from the light emitting element 220, and transmitting the SSVER signal to the signal processing and analyzing device 400. Specifically, each flash light source has a flash timing, and each of flash timings is different, and therefore the flash light source from the light emitting element and next flash light source are compared to generate a phase difference. The brain wave signal measurement device 300 includes a brain measurement system 310, a signal amplifier 320 and an analog-to-digital converter 330 and a narrow band filter 340. The brain measurement system 310 may be one of 10-20 type systems designed by the International Brain Wave Association. The brain measurement system 310 employs one electrode chip with positive attached on a brain optical zone (OZ) 620 of a user, another electrode chip with negative attached on a postauricular mastoid 630, and the other electrode chip with ground attached on a forehead 610, to measure the SSVER signal. The measured SSVER signal is amplified by the signal amplifier 320, and then the amplified SSVER signal is converted from analog signal to digital by the analog-to-digital converter 330. The converted SSVER signal is filtered by the narrow band filter 340 for eliminating brain wave with SSVER (the SSVER signal) not corresponding to the frequency of the flash light source, and advancing the signal-to-noise (S/N) ratio, so as to obtain sine brain wave signal with SSVER corresponding to the frequency of the flash light source.

The signal processing and analyzing device 400 is configured for calculating the frequency parameter and the phase parameter of the sine brain wave signal by a mathematical method, and then analyzing whether the frequency parameter and the phase parameter of the sine brain wave signal same to those of the optical flash generating device 200, if the frequency parameter and the phase parameter of the sine brain wave signal and the optical flash generating device 200 are same, the signal processing and analyzing device 400 generates a judgment result and improves the signal-to-noise (S/N) ratio. The mathematical method is one of a group consisting of the Fourier transform method, the temporal ensemble averaging method, the wavelet method, and a method for analyzing a phase of a sine wave. The control device 500 is configured for generating a control command according to the judgment result and sending out the control command to control at least one peripheral equipment.

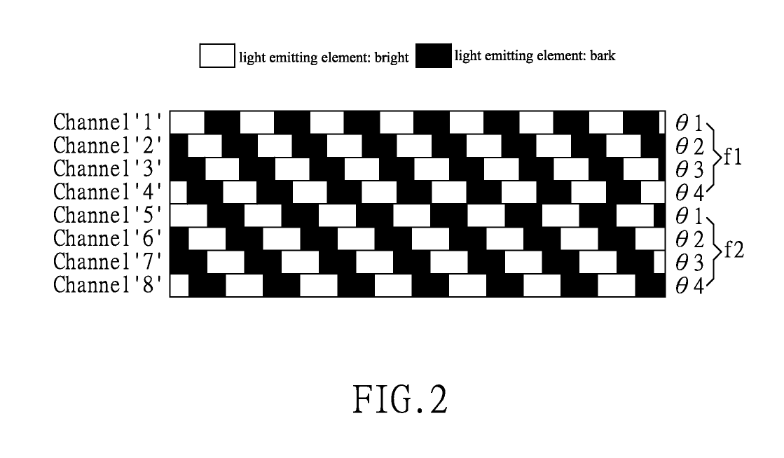

Referring to FIG. 2, the schematic, sequence chart of the flash light source generated by the optical flash generating device 200 with the multi-frequency and multi-phase encoder, is provided. The programmable chip 210 employs an operational formula

$${θ}_{n} = \frac{2 π}{x} \times ( n - 1 )$$

to form a phase code, wherein θₙ is a phase angle of a channel n; n is a serial number of a flash channel; and x is the number of the at least one light emitting element. The operational formula

$${θ}_{n} = \frac{2 π}{x} \times ( n - 1 )$$

is processed and transformed into a transforming formula with time to phase,

$${t}_{n} = \frac{{θ}_{n}}{{ω}_{m}} = \frac{1}{2 π {f}_{m}} \times \frac{2 π ( n - 1 )}{x} = \frac{{t}_{m}}{x} \times ( n - 1 )$$

by an equation θ=ωt, wherein tₙ is a delay time of the channel n; tₘ is the channel flash cycle (the inversion of the flash frequency); and fₘ is the channel flash frequency, and tₘ is the reciprocal of fₘ. If a first channel flash frequency (f1) is respectively equal to 1, 2, 3, and 4 and inserted into the transforming formula

$${t}_{n} = \frac{{θ}_{n}}{{ω}_{m}} = \frac{1}{2 π {f}_{m}} \times \frac{2 π ( n - 1 )}{x} = \frac{{t}_{m}}{x} \times ( n - 1 ) ,$$

four channel phase angles (θ₁ [symbol] θ₂ [symbol] θ₃ [symbol] θ₄) are achieved, and the delay time (t₁˜t₄) of the four channels ‘1’˜‘4’ are achieved. The light emitting element 220 is driven according to the sequence of the delay time of the four channels, to generate four flash light sources. Then, making a second channel flash frequency (f2) equal to 5, 6, 7, 8, and inserted into the transforming formula

$${t}_{n} = \frac{{θ}_{n}}{{ω}_{m}} = \frac{1}{2 π {f}_{m}} \times \frac{2 π ( n - 1 )}{x} = \frac{{t}_{m}}{x} \times ( n - 1 ) ,$$

such that another four flash light sources are generated again by using the above method. Thus, eight flash light sources are generated.

A sine wave formula S(t)=sin(ωt+θ) is used to prove that the phase code has the phase angle (θ) by the time delay. If the phase angle (θ) of the sine wave formula S(t)=sin(ωt+θ) is equal to a product of an angle speed (ω) and a time constant (t′), the sine wave formula may be transformed into S(t)=sin(ωt+ωt′)=sin ω(t+t′), and then achieve s(\hat{t}−t′)=sin(ω\hat{t}) through a variable transform \hat{t}=t+t′. From the above, it is known that the sine wave formula S(t)=sin(ωt+θ) may generate a sine wave function having the phase angle (θ) by the time delay. That is, the phase angle (θ) with flash sequence needed in the present invention is achieved by the time delay.

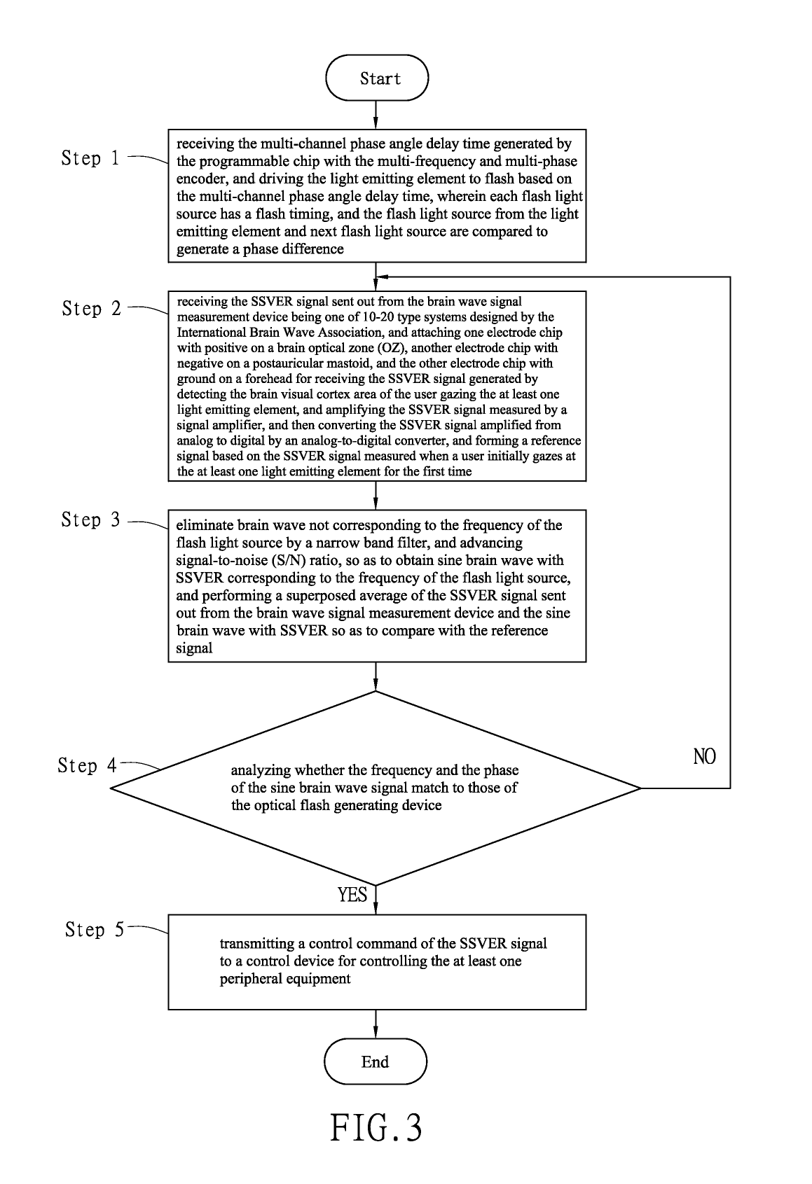

Referring to FIG. 3, when the driving control system 100 is used to measure the SSVER signal of a user for analyzing the relationship between the SSVER signal and the flash light source so as to operate the peripheral equipment according to the relationship, the signal processing and analyzing device 400 of the driving control system 100 performs following steps.

Step 1 is for receiving the multi-channel phase angle delay time generated by the programmable chip 210 with the multi-frequency and multi-phase encoder. At the same time, the programmable chip 210 transmits the multi-channel phase angle delay time to the at least one light emitting element 220 selected from one of a group consisting of a light emitting diode, a flash screen and an element configured for emitting visible light, such that the one or more light emitting element 220 flashes by the multi-channel phase angle delay time. Specifically, each flash light source has a flash timing, and each of flash timings is different, and therefore the flash light source from the light emitting element and next flash light source are compared to generate a phase difference.

Step 2 is for receiving the SSVER signal sent out from the brain wave signal measurement device 300. The SSVER signal is measured by the brain measurement system 310 in accordance with the 10-20 type systems designed by the International Brain Wave Association. The brain measurement system 310 employs one electrode chip with positive attached on a brain optical zone (OZ), another electrode chip with negative attached on a postauricular mastoid, and the other electrode chip with ground attached on a forehead for receiving the SSVER signal generated by detecting the brain visual cortex area 620 of the user, which gazes the at least one light emitting element 220. The SSVER signal is then amplified by the signal amplifier 320, and the amplified SSVER signal is converted from analog to digital by the analog-to-digital converter 330. A reference signal is formed by measuring the SSVER signal when the user gazes the at least one light emitting element 220 for the first time.

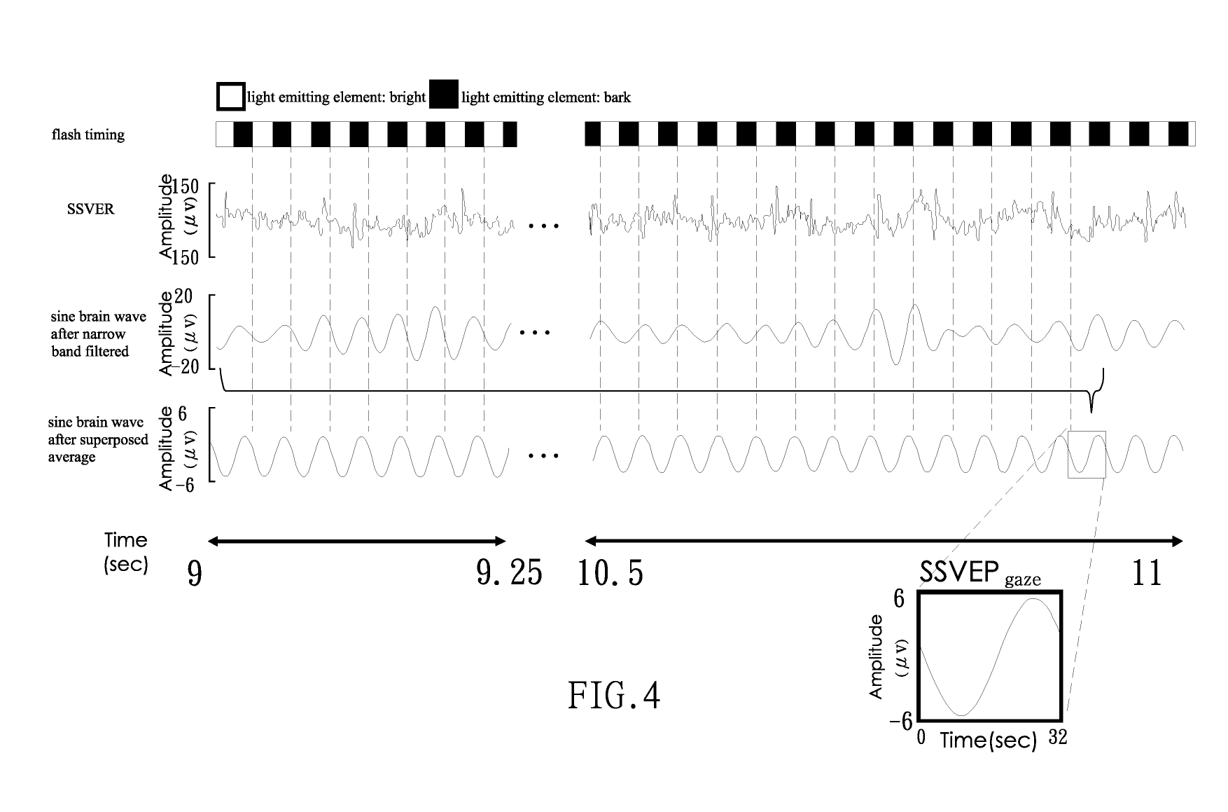

Step 3 is for eliminate brain wave with SSVER (the SSVER signal) not corresponding to the frequency of the flash light source by a narrow band filter 340, and advancing signal-to-noise (S/N) ratio, so as to obtain sine brain wave with SSVER corresponding to the frequency of the flash light source, and performing a superposed average of the SSVER signal sent out from the brain wave signal measurement device 300 and the sine brain wave with SSVER so as to compare with the reference signal (as shown in FIG. 4).

Step 4 is for analyzing whether the frequency parameter and the phase parameter of the SSVER signal sent out from the brain wave signal measurement device 300 same to those of the light emitting element 220, if yes, performing step 5; if not, turning back to perform step 2.

Step 5 is for transmitting control commands of the SSVER signal to the control device 500 for controlling the peripheral equipment, such that the processing steps by using the driving control system 100 to control the peripheral equipment are over.

From the above, the present invention has many advantages as follows.

Firstly, since the present invention employs a steady-state visual evoked response (SSVER) system with frequency and phase encoding cooperated with a random flash visual evoked potential system, the present invention may achieve the multi-channel with less flash frequency, and have many advantages, such as visual display with flash sequence in series, strong anti-interfering capability for other physiological signal, steady and quick analyzing time, and less measuring electrodes, etc. Thus the present invention is novel and unobvious.

Furthermore, the driving control system 100 and the corresponding method of the present invention, may not need peripheral neuron and muscle, and just use the brain wave signal to control the peripheral equipment for communicating with out, transmitting information, auto-motion and self-care, etc. Thus the present invention may improve the life quality of people, and is practicable.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A driving control system actuated by visual evoked brain waves which are induced by a multi-frequency and multi-phase encoder, the driving control system being configured for use of brain wave signals to control at least one of peripheral equipments, the driving control system comprising:
an optical flash generating device configured for generating at least one flash light source by a multi-frequency, multi-phase encoder, the optical flash generating device including a programmable chip and at least one light emitting element arranged therein, the programmable chip being configured to generate a multi-channel phase angle delay time by the multi-frequency, multi-phase encoder so as to drive the light emitting element to flash based on the multi-channel phase angle delay time, wherein each flash light source has a flash timing, and the flash light source from the light emitting element and next flash light source are compared to generate a phase difference;
a brain wave signal measurement device configured for measuring a steady-state visual evoked response (SSVER) signal induced by a user gazing at the flash from the light emitting element, the brain wave signal measurement device, and the brain wave signal measurement device being one of 10-20 type systems designed by the International Brain Wave Association, the brain wave signal measurement device employing one electrode chip with positive attached on a brain optical zone (OZ) of the user, another electrode chip with negative attached on a postauricular mastoid, and the other electrode chip with ground attached on a forehead for measuring the SSVER signal generated, the brain wave signal measurement device including a brain measurement system, a signal amplifier, an analog-to-digital converter and a narrow band filter arranged therein, the brain measurement system being configured for measuring the SSVER signal, the signal amplifier being configured for amplifying the SSVER signal measured by the brain measurement system, the analog-to-digital converter being configured for digitizing the SSVER signal amplified by the signal amplifier, the narrow band filter being configured for filtering the SSVER signal converted by the analog-to-digital converter to eliminate brain wave not corresponding to the frequency of the flash light source, and advance signal-to-noise (S/N) ratio, so as to obtain sine brain wave with SSVER corresponding to the frequency of the flash light source;
a signal processing and analyzing device configured for receiving the sine brain wave signal from the brain wave signal measurement device, calculating frequency and phase of the sine brain wave signal by mathematical method, and analyzing whether the frequency and the phase of the sine brain wave signal match to those of the optical flash generating device so as to generate a judgment result; and
a control device configured for generating a control command according to the judgment result and sending out the control command to control at least one peripheral equipment.

2. The driving control system as claimed in claim 1, wherein the programmable chip employs an operational formula
$${θ}_{n} = \frac{2 π}{x} \times ( n - 1 )$$
to form a phase code, θₙ is a phase angle of a channel n; n is a serial number of a flash channel; x is an amount of the at least one light emitting element; the operational formula
$${θ}_{n} = \frac{2 π}{x} \times ( n - 1 )$$
is processed and transformed into a transforming formula with time to phase
$${t}_{n} = \frac{{θ}_{n}}{{ω}_{m}} = \frac{1}{2 π {f}_{m}} \times \frac{2 π ( n - 1 )}{x} = \frac{{t}_{m}}{x} \times ( n - 1 )$$
by an equation θ=ωt, tₙ is a delay time of the channel n; tₘ is a channel flash cycle; and fₘ is a channel flash frequency, and tₘ is the reciprocal of fₘ.

3. The driving control system as claimed in claim 1, wherein the multi-channel phase angle delay time includes one of a signal channel flash frequency and a combination of combining at least two channel flash frequencies.

4. The driving control system as claimed in claim 1, wherein the programmable chip is one of a group consisting of a field programmable gate array (FPGA), a single chip and a microprocessor.

5. The driving control system as claimed in claim 1, wherein the at least one light emitting element is one of a group consisting of a light emitting diode, a flash screen and an element configured for emitting visible light.

6. The driving control system as claimed in claim 1, wherein the mathematical method is one of a group consisting of the Fourier transform method, the temporal ensemble averaging method, the wavelet method, and a method configured for analyzing a phase of a sine wave.

7. A method used into a driving control system for visual evoked brain wave by multi-frequency and multi-phase encoder, the method being configured for using brain wave signals to control at least one peripheral equipment, the method employing a signal processing and analyzing device of the driving control system to perform following steps:
receiving a multi-channel phase angle delay time generated by a programmable chip with a multi-frequency and multi-phase encoder, the programmable chip transmitting the multi-channel phase angle delay time to at least one light emitting element for driving and flashing the at least one light emitting element, wherein each flash light source has a flash timing, and the flash light source from the light emitting element and next flash light source are compared to generate a phase difference;
receiving the SSVER signal sent out from the brain wave signal measurement device being one of 10-20 type systems designed by the International Brain Wave Association, and attaching one electrode chip with positive on a brain optical zone (OZ), another electrode chip with negative on a postauricular mastoid, and the other electrode chip with ground on a forehead for receiving the SSVER signal generated by detecting the brain visual cortex area of the user gazing the at least one light emitting element, and amplifying the SSVER signal measured by a signal amplifier, and then converting the SSVER signal amplified from analog to digital by an analog-to-digital converter, and forming a reference signal based on the SSVER signal measured when a user initially gazes at the light emitting element first time;
eliminate brain wave not corresponding to the frequency of the flash light source by a narrow band filter, and advancing signal-to-noise (S/N) ratio, so as to obtain sine brain wave with SSVER corresponding to the frequency of the flash light source, and performing a superposed average of the SSVER signal sent out from the brain wave signal measurement device and the sine brain wave with SSVER so as to compare with the reference signal; and
transmitting a control command of the SSVER signal to a control device for controlling the at least one peripheral equipment, if the SSVER signal having both the same frequency parameter and phase parameter matched to those of the at least one light emitting element.

8. The method as claimed in claim 7, wherein the programmable chip employs an operational formula
$${θ}_{n} = \frac{2 π}{x} \times ( n - 1 )$$
to form a phase code, θₙ is a phase angle of a channel n; n is a serial number of a flash channel; x is an amount of the at least one light emitting element; the operational formula
$${θ}_{n} = \frac{2 π}{x} \times ( n - 1 )$$
is processed and transformed into a transforming formula with time to phase
$${t}_{n} = \frac{{θ}_{n}}{{ω}_{m}} = \frac{1}{2 π {f}_{m}} \times \frac{2 π ( n - 1 )}{x} = \frac{{t}_{m}}{x} \times ( n - 1 )$$
by an equation θ=ωt, tₙ is a delay time of the channel n; tₘ is a channel flash cycle; and fₘ is a channel flash frequency, and tₘ is the reciprocal of fₘ.

9. The method as claimed in claim 7, wherein the multi-channel phase angle delay time includes one of a signal channel flash frequency and a combination of combining at least two channel flash frequencies.

10. The method as claimed in claim 7, wherein the programmable chip is one of a group consisting of a field programmable gate array (FPGA), a single chip and a microprocessor.

11. The method as claimed in claim 7, wherein the at least one light emitting element is one of a group consisting of a light emitting diode, a flash screen and an element configured for emitting visible light.
